(19) United States
(12) Patent Application Publication
(10) Pub. No.: US 2016/0267799 A1
(43) Pub. Date: Sep. 15, 2016

(54) SYSTEMS AND METHODS FOR COGNITIVE TRAINING WITH ADAPTIVE MOTIVATION FEATURES

(71) Applicant: CurriculaWorks, Burlingame, CA (US)

(72) Inventors: Deanna Terzian, San Francisco, CA (US); Lynn Krause, Mt. View, CA (US); Charles Terzian, St. Petersburg, FL (US); Francis Kelly, Albany, CA (US)

(21) Appl. No.: 15/059,012

(22) Filed: Mar. 2, 2016

Related U.S. Application Data
(60) Provisional application No. 62/130,332, filed on Mar. 9, 2015.

(51) Int. Cl. G09B 5/02; G09B 19/00

(52) U.S. Cl. CPC G09B 5/02; G09B 19/00

(57) ABSTRACT

A method of cognitive training includes presenting cognitive training exercises as an integral part of the gameplay of a first person shooter (“FPS”). The cognitive training exercises can include mental set switching (“MSS”) exercises, updating exercises (e.g., dual n-back tests), and inhibiting exercises (e.g., sustained focus tasks). Adaptive motivation techniques—that is, the user-specific delivery of motivating elements—can also be employed to motivate a user to initiate and continue cognitive training.

### CROSS-REFERENCE TO RELATED APPLICATION

This application claims the benefit of U.S. provisional application No. 62/130,332, filed 9 Mar. 2015, which is hereby incorporated by reference as though fully set forth herein.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office file or records, but otherwise reserves all copyright rights whatsoever.

### BACKGROUND

The instant disclosure relates generally to computerized training. In particular, the instant disclosure relates to immersive training programs that include adaptive motivation aspects.

Neuropsychological research has identified a number of critical executive functions that support complex cognitive activities of all kinds. For example, some researchers have theorized that three core executive functions—mental set switching (“MSS”), updating and monitoring (“updating”), and inhibiting—account for the majority of executive cognition.

MSS requires a person to switch between mental tasks or shift attention back and forth between cognitive operations. Updating requires the person to monitor incoming stimuli and continuously overwrite old information with newer and more relevant information. Inhibiting is the deliberate, controlled suppression of prepotent responses.

These three functions, each a low-level component, interactively combine to create the thinking operations required for many cognitive activities. In particular, the activities of learning and comprehending are tied to these executive functions. For example, updating capacity (also referred to as “working memory capacity”) has been tied to language comprehension and the ability to follow spoken directions. Similarly, MSS abilities are thought to be central to cognitive flexibility, which is important for how information is explored and how knowledge structures are formed. Likewise, inhibitory focus is important to self-directed learning and the ability of an individual to concentrate in class.

Like many other human endeavors, the development of strong executive functioning can be assisted by training and practice. Cognitive training often includes digital platforms that deliver a series of stimuli to the user, requiring the user to respond in a way that taxes specific cognitive functions. These extant systems, however, take a disjointed, rather than immersive, approach to cognitive training.

Moreover, motivating trainees to proactively engage in prolonged computer-based training is challenging. Motivation diminishes over time, such that, over the course of training, the same reward stimulus will diminish in effectiveness. Motivation is also dynamic; that is, what motivates people to start training many not motivate them to continue training or motivate them to achieve new records. Motivation is also individualized—there is no “one size fits all” solution, and what motivates one person may not motivate another.

In the early 1990s, Martin E. Ford of Stanford University developed a framework known as Motivational Systems Theory (“MST”) to understand and leverage motivation in learning. MST integrates concepts from over 20 different motivation theories to provide a structured approach to understanding one's motivation. In particular, MST describes motivation as a combination of three processes that interact to determine the direction and intensity of an individual's actions: personal goals, personal agency beliefs (“PAB”), and emotions.

Extant systems are primitive in their approach to motivation. For example, they provide non-individualized motivations—all users receive the same motivators, according to a linear progression. Put simply, extant systems do not treat motivators as discrete units that can be delivered independently, dynamically, and non-linearly.

### BRIEF SUMMARY

Disclosed herein is a method of cognitive training, including: establishing a first person shooter (“FPS”) environment; and presenting a cognitive training exercise within the FPS environment as an integral part of FPS gameplay. The cognitive training exercise can be an MSS task, an updating task (e.g., an n-back test, such as a single or dual n-back test), and/or an inhibiting task (e.g., a sustained focus task).

In certain aspects, the method also includes delivering motivators to a user of the FPS environment. Thus, it is contemplated that a motivational profile for the user, including the user's personal goals, the user's PABs, and the user's emotions, will be developed, for example by having the user complete PAB and/or emotional self-assessments. The motivational profile can also be updated based upon the user's performance in the FPS environment.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 is a block diagram showing the establishment of a Motivator Basket.

FIG. 2 is a flow diagram showing an adaptive motivation process.

### DETAILED DESCRIPTION

The present disclosure provides methods and systems for immersive cognitive training. For purposes of illustration, several exemplary embodiments will be described herein in detail in the context of a post-apocalyptic horror first-person shooter (“FPS”) game, and in particular an FPS set against a “zombie apocalypse” backdrop. For example, the player can take on the role of a special operations soldier (e.g., a Navy SEAL) fighting enemies that are infected with a biological agent, with the cognitive training exercises that the player is expected to complete taking the form of “missions” to combat the zombie hordes.

The nature of an FPS will be familiar to a person of ordinary skill in the art, such that a detailed description thereof is not necessary to the understanding of the instant disclosure. In brief, however, an FPS is a type of three-dimensional game, often (but not necessarily) a combat simulation (thus the inclusion of the term “shooter” in the name of the genre), that features a first-person point of view in which the player sees the action as if through the eyes of the on-screen player character (“PC”). FPS can be contrasted with third person shooter (“TPS”) games, where the player usually looks “over the shoulder” of the PC.

The player is able both to move the PC through the on-screen environment (referred to herein as the “world”) and engage non-player characters (“NPCs”). NPCs may be allies (e.g., fellow Navy SEALs), enemies (e.g., zombies), or neutral characters (e.g., civilians). The typical engagement with each type of NPC will be familiar to those of skill in the art. In the case of enemy NPCs, the player will typically engage with some form of weapon in an effort to injure or kill the enemy. Allied NPCs can be engaged with helpful items (e.g., a first aid kit to assist a wounded comrade). Often, neutral NPCs are engaged only with dialogue, though many so-called “fetch quests” will require the player to return a certain object to or accomplish a particular task for a neutral NPC in order to complete an in-game objective.

It should be understood that the teachings herein can be applied outside the context of a traditional FPS, or even outside the FPS genre more generally, depending, for example, on the intended audience (e.g., the “zombie apocalypse” theme discussed herein likely would not be appropriate for younger users). In fact, it is contemplated that the teachings herein can be applied not only in the context of an FPS, but also in the context of a TPS or other platform.

In general, the methods and systems disclosed herein are immersive in that they incorporate cognitive training activities into and as integral elements of the gameplay within the context of a game where the player has control over the on-screen PC regardless of the particular vantage point (e.g., first-person, third-person, side-scrolling or vertically-scrolling, etc.), although certain vantage points will offer more immersion than others. This immersion is more desirable than extant cognitive trainers, which present cognitive training activities in isolation (that is, as ends in and of themselves rather than as means to an end and part of a larger, integrated whole).

Put another way, in the systems and methods disclosed herein, the gameplay and the cognitive training are one and the same. This is to be contrasted with requiring the player to complete cognitive training “mini games” or puzzles within the context of a “pure” FPS, where the primary gameplay mechanic is to kill as many enemy NPCs as possible, to escort a neutral NPC to safety, or to accomplish some other non-cognitive objective. In the former case, the cognitive training is seamlessly part and parcel of the FPS. In the latter case, the player is temporarily taken out of the larger in-game universe to engage in a disconnected cognitive activity, which can spoil the immersive feel of the game and detract from the effectiveness of the training. Indeed, extant game-based cognitive training exercises are not unlike the “shell game”-style videos played between innings at baseball games—they are a distraction from the main event (the baseball game) rather than the main event itself.

The FPS disclosed herein can include an MSS aspect. In particular, the MSS aspect can require the player to interpret on-screen symbols and interact with NPCs accordingly. The rules for interpreting the on-screen symbols can periodically change.

For example, the player can be assigned a patrol mission through the streets of a zombie-infested city. As the player navigates the world and encounters NPCs, the player can be presented with on-screen symbols that he or she must quickly interpret to determine the stage of infection afflicting each NPC (e.g., full zombie with no hope of recovery, highly infected zombie with hope of recovery, moderately infected civilian, uninfected). The user can then be required to engage each NPC with a different weapon or implement specific to the stage of infection (e.g., using a shotgun for a highly infected zombie vs. an inoculation for an uninfected NPC). Thus, the user must apply pattern recognition techniques to read the symbols and infer therefrom the appropriate weapon or implement to use to engage the approaching NPC. The symbols can change periodically (e.g., after a certain number of correct decisions by the player), requiring the user to abandon the previous heuristic and infer and adopt a new one.

Consequences can be enforced for failing to properly interpret the symbols in a timely fashion. For example, the player can receive a penalty (e.g., be subjected to court martial and demoted in rank) for engaging an uninfected NPC with a shotgun as if fully infected, or can lose health points if a fully infected zombie is not recognized before it can attack (and thus potentially infect) the PC or an allied NPC (e.g., a squad member). Conversely, rewards (e.g., promotions, medals) can be provided for successful performance.

The Appendix to the Specification includes sample code for the implementation of an MSS aspect in an FPS.

The FPS can include a sustained focus task (“SFT”) aspect to train the inhibiting function. For example, the player can be assigned a mission to serve as a spotter for an allied NPC sniper. In this role, the player can be shown an aerial view of an area populated by a herd of NPCs (e.g., a simulated view from an unmanned aerial vehicle, often referred to as a “drone”). The view can include a night-vision or similar effect to obscure certain details of the NPCs. The player can then initiate a keystroke or other sequence that identifies a certain number of “targets” within the herd (e.g. 1-5) for a short period of time (e.g., 3-5 seconds). Thereafter, the targets and the balance of the herd continue to mill about for a longer “focus period” of between about one minute and three minutes. At the end of the focus period, the player must identify the targets within the herd, such that the NPC sniper can neutralize them.

As a variation on the scenario described above, the player can be assigned a sniper mission. The player can be shown a view of the NPC-populated area as if looking through a scope and initiate the target identification sequence. The player can then request approval from his or her commander to engage the targets, with the focus period simulating the amount of time it requires the commander to grant such approval.

As with the MSS aspect discussed above, the SFT aspect can include associated rewards for superior performance and/or consequences for poor performance.

The FPS can also include an aspect to train the updating function. For example, between field missions, and much as in real life, the player can be required to engage in training to prepare for operations. This “Bioagent Resistance Training” (or “BRT”) can take the form of an n-back test, such as a single or dual n-back test. For successful completion of BRT, the PC can receive an increased resistance to the infection afflicting others. Conversely, skipping and/or failing BRT can reduce the PC's resistance.

As discussed above, the foregoing aspects are the storyline of the FPS, rather than disjointed elements within the storyline. As such, their implementation can be customizable and configurable, which allows the game to be optimized for a particular player. For example, a user who demonstrates a high inhibiting function, either initially or over repeated play-throughs, can be presented with an increased difficulty SFT (e.g., the number of targets the player must track can increase and/or the focus period can be lengthened).

The emphasis on a particular executive function can also be adjusted, such as by adjusting the time in or frequency of a given task (e.g., BRT vs. SFT vs. MSS). For example, if a player has a low resistance to the infection, an NPC in the form of a superior officer can order the PC to undergo additional BRT.

Emphasis can also be tailored, for example, by adjusting the frequency with which the MSS heuristic changes or by adjusting the stream speed or n-value in the simulated BRT. It is also contemplated that additional modules, missions, and the like, for example in the form of downloadable content (“DLC”), can be added to support additional training in the future.

In order to motivate users to continue playing, the FPS can include adaptive motivation aspects. As used herein, the term “adaptive motivation” refers to the use of assessment tools to capture information about the player's individual motivation and to apply motivators accordingly. The term “motivator” is used herein to refer to distinct motivating elements within the FPS software architecture, which allows these motivating elements to be turned on or off and/or delivered according to a variable schedule (e.g., according to flexible logic implemented in one or more adaptive motivation algorithms as described herein).

As those of ordinary skill in the art of game design will appreciate from the instant disclosure, motivating elements can take various forms. For example, the medals and promotions described above are motivating elements. If these motivating elements are provided according to flexible logic, they are also motivators within the meaning of the present teachings. On the other hand, although potentially motivating to a player, a promotion or medal (or other motivating element) would not meet the instant definition of “motivator” if it were simply awarded to every player according to a fixed schedule (e.g., upon completion of a certain number of missions or the achievement of a particular score). A motivator, as disclosed herein, is individualized to a particular user.

Thus, adaptive motivation according to the teachings herein creates, and continually updates, a motivational profile for the user and adapts the delivery of motivators based on, inter alia, the user's assessed characteristics, inferred motivational state, and responses to incentives. Ford's MST principles can be applied to good advantage in this context.

Broadly speaking, adaptive motivation as disclosed herein can be divided into three phases. In a first phase, the user's motivational processes (e.g., the user's personal goals, PABs, and emotions) are learned and an initial motivational profile is constructed. In a second phase, the user's patterns of performance and engagement are tracked to infer the user's motivational requirements. In a third phase, the information tracked in the second phase is used to adapt the motivational content for the user in order to deliver motivators and to update the user's motivational profile accordingly.

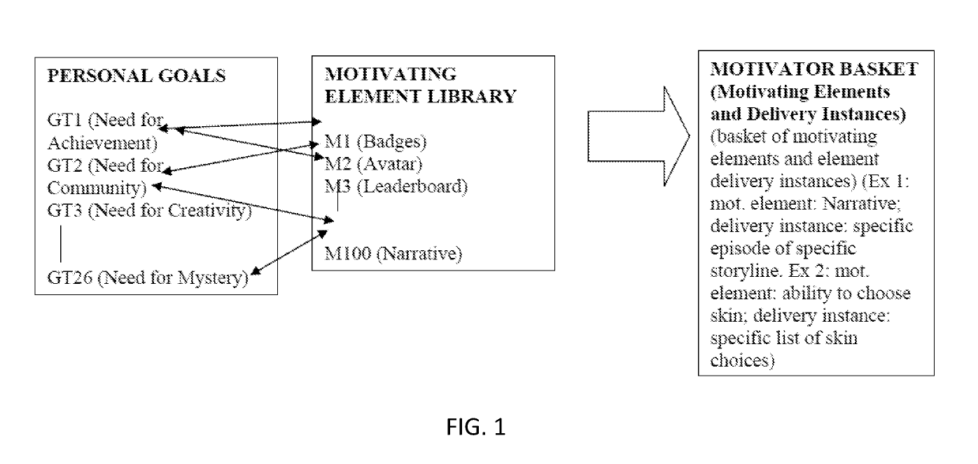

Breaking these phases down further, adaptive motivation begins with a step of identifying the user's personal goals. These personal goals can be a subset of the Ford and Nichols Taxonomy of Human Goals that will be familiar to those of ordinary skill in the art. Indeed, it is understood that, although the Ford and Nichols Taxonomy of Human Goals provides a classification scheme for all human goals, there are powerful individual differences in the core personal goals that are important to people, even amongst those goal themes that are considered more universal to humans generally (e.g., competence, autonomy, and relatedness). For example, as shown in FIG. 1, a particular user's core personal goals can include “Need for Achievement” (i.e., Mastery), Need for Community (i.e., Belongingness), Need for Creativity (i.e., Task and/or Intellectual Creativity), Need for Mystery (i.e., Exploration), and so forth.

Once the user's core personal goals have been identified, they can be mapped to motivating elements within a Motivating Element Library that correspond to and address these identified personal goals. The Motivating Element Library can be a database that stores all the motivating elements that can be delivered within the context of the FPS. For purposes of illustration, Need for Achievement can map to Badges and Leaderboards; Need for Community can map to Avatar and Narrative, and Need for Mystery can map to Narrative. Of course, badges, avatars, and leaderboards are only examples of motivating elements, and those of ordinary skill in the art of game design will appreciate that there are numerous types of motivating elements, all of which are contemplated as within the spirit and scope of this disclosure.

Each motivating element within the Motivating Element Library can also have an associated set of properties, including, for example, category (e.g., display, activity), type (e.g., Narrative, Avatar), type instance (e.g., specific assets for Narrative story, Avatar image and accessories), and weighted correlations to personal goals, PABs, and emotions.

The user's PABs can be gathered by self-reporting, such as by using a personal goal self-assessment (e.g., http://www.implicitself.com). Emotions can likewise be gathered by self-reporting (e.g., by allowing the user to choose an emoticon that best captures his or her feelings). Emotions can also be inferred from biofeedback from the player. It is also contemplated that PABs and emotions can be inferred from the player's in-game behavior, which can be employed to good advantage in updating the user's motivational profile as discussed below.

Once the user's personal goals have been mapped to motivating elements and the user's PABs and emotions have been identified, an initial set of delivery conditions customized to the user can be developed through motivation delivery algorithms. These motivation delivery algorithms determine what motivating elements to deliver, how many motivating elements to deliver, when to deliver motivating elements, and how to deliver motivating elements as a function of the user's current state properties, which include both information about the user's person (e.g., self-reported and/or inferred PABs), and information about the user's performance (current and/or historical).

For example, one motivation delivery algorithm might be as follows: If the user's personal goals include Need for Achievement, but the user's emotional state indicates a lack of self-confidence, the PC may receive a motivational speech from an NPC commander immediately after starting the game.

Another algorithm might be: If Need for Community ranks high in the player's personal goals, and the player has exhibited high performance on a learning activity, the player might be invited to share those stellar results, and tips on how they were achieved, with peers.

The ordinarily skilled artisan will appreciate how to construct additional motivation delivery algorithms from the foregoing examples.

The resulting combination of motivating elements mapped to individual goals and their respective delivery conditions is termed a “Motivator Basket.” In other words, the user's Motivator Basket can include a subset of the Motivating Element Library weighted to reflect the user's individual goals, PABs, and/or emotions. It can also include user-specific delivery settings, such as display duration of the leaderboard or the number of narrative segments presented. For example, the motivating element Narrative can be delivered as a specifically selected episode of a relevant or suitable storyline, (e.g., the presentation of a particular FPS mission at a certain time dictated by the player's motivation profile), where the progression of the storyline is dictated not by a rigid script, but rather by the user's goals, emotions, and PABs.

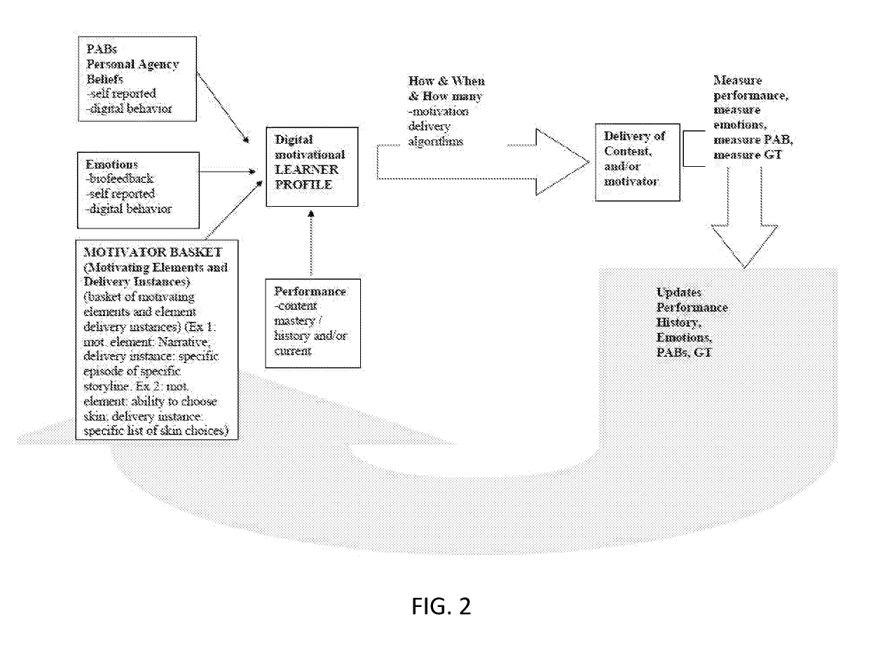

As shown in FIG. 2, the user's PABs, the user's emotions, and the user's individualized Motivator Basket are combined to create the user's initial motivational profile. Following delivery of motivators or other content, the player's performance, emotions, PABs, and goal themes can be measured (e.g., biofeedback, additional self-reporting), with this information used to update the player's motivational profile.

Although several embodiments of this invention have been described above with a certain degree of particularity, those skilled in the art could make numerous alterations to the disclosed embodiments without departing from the spirit or scope of this invention.

For example, although the teachings herein are presented in the context of an FPS, they can be employed to good advantage in any game genre, and, indeed, any learning or training system, whether or not gamified (e.g., an educational system to teach early literacy).

As another example, the immersive approach to training discussed herein is not limited to FPS, and can be applied to numerous training and/or educational domains (e.g., an immersive game designed for early literacy acquisition could integrate phoneme recognition or spelling into gameplay).

As still another example, adaptive motivation as disclosed herein is not limited to Ford's MST, but rather is applicable to other theories of human motivation. The ordinarily skilled artisan will understand how to adapt the principles disclosed herein to these other contexts and concepts.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

It is intended that all matter contained in the above description or shown in the accompanying drawings shall be interpreted as illustrative only and not limiting. Changes in detail or structure may be made without departing from the spirit of the invention as defined in the appended claims.

What is claimed is:

1. A method of cognitive training, comprising:
establishing a first person shooter (“FPS”) environment;
presenting a cognitive training exercise within the FPS environment as an integral part of FPS gameplay.

2. The method according to claim 1, wherein the cognitive training exercise comprises a mental set switching (“MSS”) task integrated into the FPS gameplay.

3. The method according to claim 1, wherein the cognitive training exercise comprises an updating task integrated into the FPS gameplay.

4. The method according to claim 3, wherein the updating task comprises an n-back test.

5. The method according to claim 4, wherein the updating task comprises a dual n-back test.

6. The method according to claim 1, wherein the cognitive training exercise comprises an inhibiting task integrated into the FPS gameplay.

7. The method according to claim 1, further comprising delivering motivators to a user of the FPS environment.

8. The method according to claim 6, further comprising developing a motivational profile for the user of the FPS environment, wherein the motivational profile comprises the user's personal goals, the user's personal agency beliefs (“PABs”), and the user's emotions.

9. The method according to claim 7, further comprising updating the motivational profile for the user based upon the user's performance in the FPS environment.

10. The method according to claim 7, wherein developing a motivational profile comprises receiving the user's PAB self-assessment input.
